(19) United States
(12) Patent Application Publication
(10) Pub. No.: US 2007/0075973 A1
(43) Pub. Date: Apr. 5, 2007

(54) Mouse having a digital television receiving function

(75) Inventors: Yung-Hsiang Tseng, Taipei City (TW); Nan-Lin Li, Taoyuan City (TW)

Correspondence Address: TROXELL LAW OFFICE PLLC;ONE SKYLINE PLACE, SUITE 1404, 5205 LEESBURG PIKE, FALLS CHAURCH, VA, 22041, US

(73) Assignee: Wieson Technologies Co., Ltd.

(21) Appl. No.: 11/315,166

(22) Filed: Dec. 23, 2005

(30) Foreign Application Priority Data
Sep. 30, 2005 (TW) 094216928

(51) Int. Cl. G09G 5/08

(52) U.S. Cl. 345/163

(57) ABSTRACT

The present invention relates to a mouse having a digital television receiving function and the mouse comprises a casing having an upper casing and a lower casing, a mouse function unit having an interface for detecting mouse coordinates and sending the mouse coordinates out from the interface, a digital television receiver further includes an interface and a radio frequency interface, an antenna for receiving a radio digital television signal and passing the signal to the digital television receiver and decoding the signal into a digital television signal, and a hub separately coupled to the mouse function unit and the digital television receiver for connecting a computer device by a cable, such that a user can use a software on the computer device to control and view the digital television signal received by the digital television receiver.

### BACKGROUND OF THE INVENTION

1. Field of the Invention

The present invention relates to a computer input device having a digital television receiving function, and more particularly to a mouse having a digital television receiving function that includes a built-in digital television receiver and a built-in antenna, such that the mouse can control a computer device by software to view the digital television signal transmitted from the digital television receiver.

2. Description of the Related Art

The purpose of a present mouse is to send the coordinates of the mouse to a computer by a cable or a wireless method for processing or controlling the cursor of the computer to execute programs etc. The modem mouse only improves the movements of the press buttons/rollers or adds a wireless function to the mouse, but the mouse is just a general input device only.

Referring to FIG. 6 for the schematic view of a connecting a computer to a digital television receiving box for viewing a digital television program according to a prior art, a digital television receiving box 100 is used for receiving digital television signals if it is necessary to view a digital television program from a computer. The digital television receiving box 100 includes a USB interface (not shown in the figure) for connecting the digital television receiving box 100 to a USB port (not shown in the figure) of a computer 110, so as to facilitate users to view a digital television program by controlling a media player of the computer 110. However, the foregoing digital television receiving box 100 is connected to the computer 110 by a cable, and thus causing a mess on the desktop of the computer. In addition, users need to purchase a mouse 120 and a digital television receiving box 110, and thus incurring additional cost to users.

In view of the foregoing shortcomings of the prior art, we need a mouse having a digital television receiving function that includes a built-in mouse unit and a built-in digital television receiver, such that the structure of the foregoing mouse can simplify the cable connection of the computer device, in addition to saving the purchasing cost for users.

### SUMMARY OF THE INVENTION

The primary objective of the present invention is to provide a mouse having a digital television receiving function that includes a built-in mouse unit and a built-in digital television receiver to save the purchasing cost for users.

Another objective of the present invention is to provide a mouse having a digital television receiving function that includes a built-in mouse unit and a built-in digital television receiver to simplify the cable connection of the computer device.

To achieve the foregoing objectives, the mouse having a digital television receiving function in accordance with the present invention comprises a casing including an upper casing and a lower casing; a mouse function unit having an interface for detecting the mouse coordinates and sending out the mouse coordinates from the interface, a digital television receiver further includes an interface and a radio frequency interface, an antenna for receiving a wireless digital television signal and passing the wireless digital television signal to the digital television receiver for decoding the signal into a digital television signal, and a hub separately coupled to the mouse function unit and the digital television receiver and coupled to a computer device by a cable, such that a user can view the digital television signal from the computer device by using a software.

To achieve the foregoing objectives, the mouse having a digital television receiving function in accordance with the present invention comprises a casing including an upper casing and a lower casing coupled with each other to define a containing space, a mouse function unit installed in the containing space and having an interface for detecting the mouse coordinates and sending out the mouse coordinates from the interface, a digital television receiver installed into the containing space and further including an interface and a radio frequency interface, an antenna coupled to the radio frequency interface for receiving a wireless digital television signal and passing the wireless digital television signal to the digital television receiver for decoding the signal into a digital television signal, a hub installed in the containing space and separately coupled to the mouse function unit and the digital television receiver, and a wireless network unit installed in the containing space and coupled to the hub for connecting a computer device by a wireless method, and the mouse coordinates and the digital television signal are sent to the computer device, such that a user can view a digital television signal transmitted from the digital television receiver on the computer device by a software.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is an exploded view of a mouse having a digital television receiving function according to a preferred embodiment of the present invention;

FIG. 2 a schematic view of a mouse having a digital television receiving function and a computer according to the present invention;

FIGS. 3(a) to 3(d) are schematic views of an antenna adopted by the present invention;

FIG. 4 is a schematic view of a mouse having a digital television receiving function according to another preferred embodiment of the present invention;

FIG. 5 is a schematic view of a mouse having a digital television receiving function and a computer according to another preferred embodiment of the present invention; and

FIG. 6 is a schematic view of a connecting a computer to a digital television receiving box for viewing a digital television program according to a prior art.

### DETAILED DESCRIPTION OF THE PREFERRED EMBODIMENTS

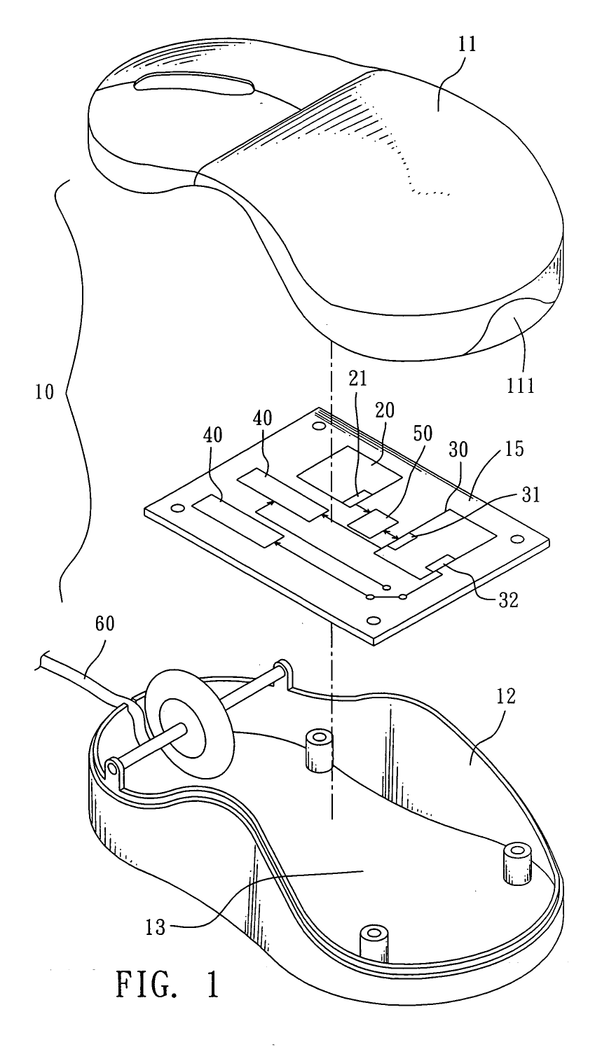

Referring to FIG. 1 for the exploded view of a mouse having a digital television receiving function according to a preferred embodiment of the present invention, the mouse having a digital television receiving function in accordance with the present invention comprises a casing 10, a mouse function unit 20, a digital television receiver 30, an antenna 40, and a hub 50.

The casing 10 includes an upper casing 11 and a lower casing 12 engaged with each other to define a containing space 13, and a side of the upper casing 11 preferably includes a transparent window 111. In addition, the containing space 13 preferably includes a printed circuit board 15 for accommodating the components including the mouse function unit 20, digital television receiver 30, antenna 40 and hub 50, etc.

The mouse function unit 20 installed on the printed circuit board 15 and disposed in the containing space 13 has an interface 21 including but not limited to a USB interface for detecting the mouse coordinates and sending out the mouse coordinates from the interface 21, wherein the mouse function unit 20 could be an optical mouse or a trackball mouse having a roller and a plurality of press keys, but the general mouse is a prior art, and thus will not be described here.

The digital television receiver 30 installed on the printed circuit board 15 and disposed in the containing space 13 further includes an interface 31 and a radio frequency (RF) interface 32, wherein the interface 31 including but not limited to a USB interface can receive an external digital television program from the antenna 40. The digital television receiver 30 further includes an infrared receiver 33 exposed from the window 111 of the upper casing 11 for receiving the control of a remote control (not shown in the figure).

The antenna 40 installed on the printed circuit board 15 and coupled to the radio frequency interface 32 can receive a radio digital television signal and the radio frequency interface 32 passes the signal to the digital television receiver 30 for decoding the signal into a digital television signal. The antenna 40 could be a built-in multi-frequency antenna or an external multi-frequency antenna. The built-in multi-frequency antenna includes but not limited to a coil, a ceramic antenna, or a coil antenna, and the external multi-frequency antenna includes but not limited to an overflow antenna.

The hub 50 installed on the printed circuit board 15 and disposed in the containing space 13 is separately coupled to the mouse function unit 20 and the digital television receiver 30 for connecting a computer device 70 by a cable 60, wherein the hub 50 is a USB hub installed on the printed circuit board 15 and coupled to the mouse function unit 20 for detecting the mouse coordinates and the digital television receiver 30, and the mouse coordinates are decoded into a digital television signal and sent to the computer device through the cable 60.

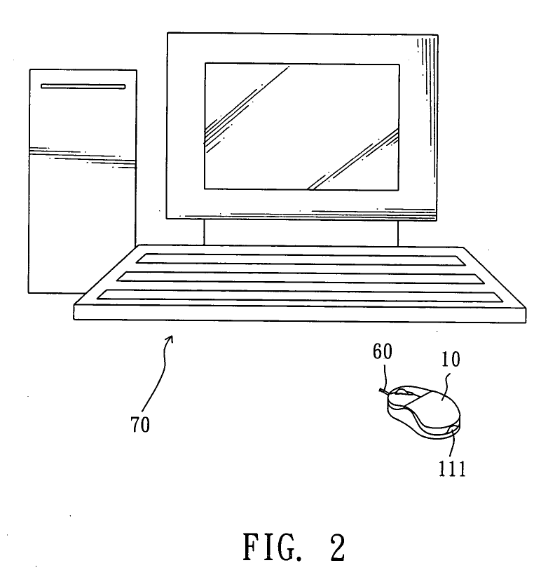

Refer to FIG. 2 for the schematic view of a mouse having a digital television receiving function and a computer according to the present invention. In the application, a user can connect the cable 60 to a USB port (not shown in the figure) of a computer 70, and the computer device 70 uses a software including but not limited to a Microsoft Media Player program to control and view a digital television program received by the digital television receiver 30. Therefore, the connection is very simple, and simply like the connection to a general cable mouse, and there is only one cable connected between the computer 70 and the mouse having a digital television receiving function of the present invention, so as to simplify the cable connection. Further, the mouse function unit 20, digital television receiver 30, and hub 50 of the present invention are integrated as a whole to reduce the user's purchasing cost, and thus the present invention surely can overcome the shortcomings of the prior art mouse and digital television receiver.

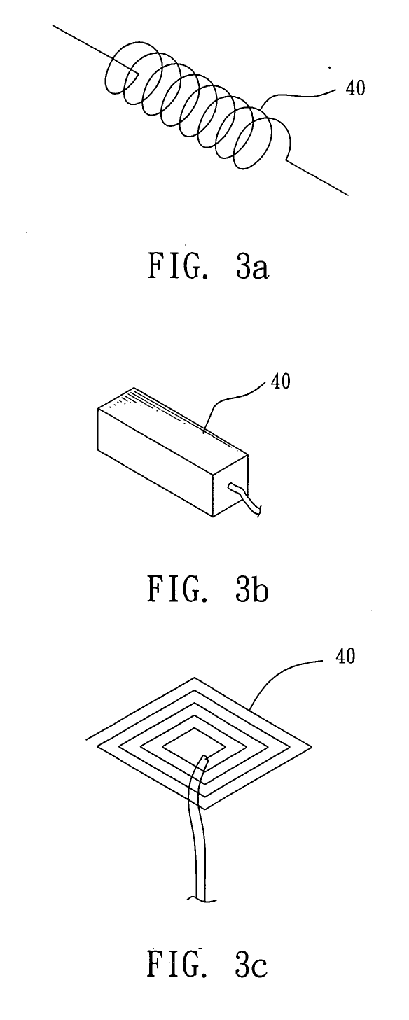

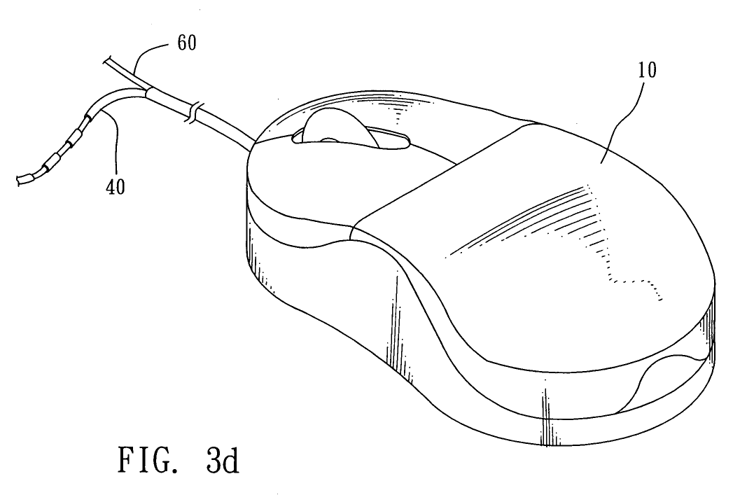

Refer to FIGS. 3(a) to 3(d ) for the schematic views of an antenna 40 adopted by the present invention. In FIG. 3(a), the antenna 40 of the invention is formed by winding a coil which is disposed in the containing space 13 for receiving the radio digital television signal. In FIG. 3(b), the antenna 40 of the invention could be a ceramic antenna which is disposed in the containing space 13 for receiving the radio digital television signal. In FIG. 3(c), the antenna 40 of the invention could be a coil antenna which is installed into the containing space 13 for receiving the radio digital television signal. In FIG. 3(d), the antenna 40 of the invention could be an overflow antenna, wherein the metal covering layer of the conductive wire and the external insulating layer are removed to form a plurality of exposed sections for overflowing signals, and the antenna 40 can be integrated with the cable 60 for receiving the radio digital television signal.

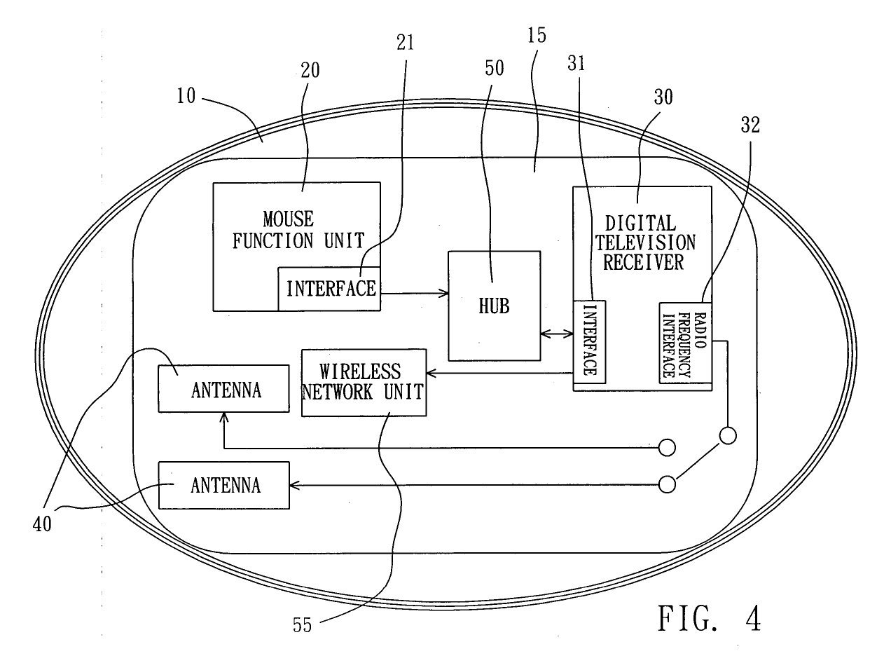

Referring to FIG. 4 for the schematic view of a mouse having a digital television receiving function according to another preferred embodiment of the present invention, the mouse having a digital television receiving function in accordance with the present invention comprises a casing 10, a mouse function unit 20, a digital television receiver 30, an antenna 40, a hub 50, and a wireless network unit 55.

The casing 10, mouse function unit 20, digital television receiver 30, antenna 40, and hub 50 are installed on the printed circuit board 15 and their functions are the same as illustrated in FIG. 1, and thus will not be described further here.

The wireless network unit 55 is disposed in the containing space 13 and coupled to the hub 50 for connecting the computer device 70 by a wireless method and sending the mouse coordinates and the digital television signal to the computer device 70, wherein the wireless network unit 55 is an IEEE802.11a/b/c/d/g wireless network. Therefore, there is no cable 70 between the mouse having a digital television receiving function and the computer device 70, and thus the wiring can be simplified.

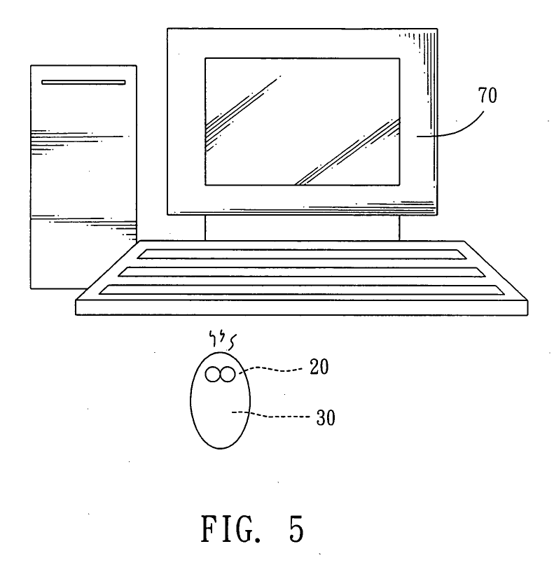

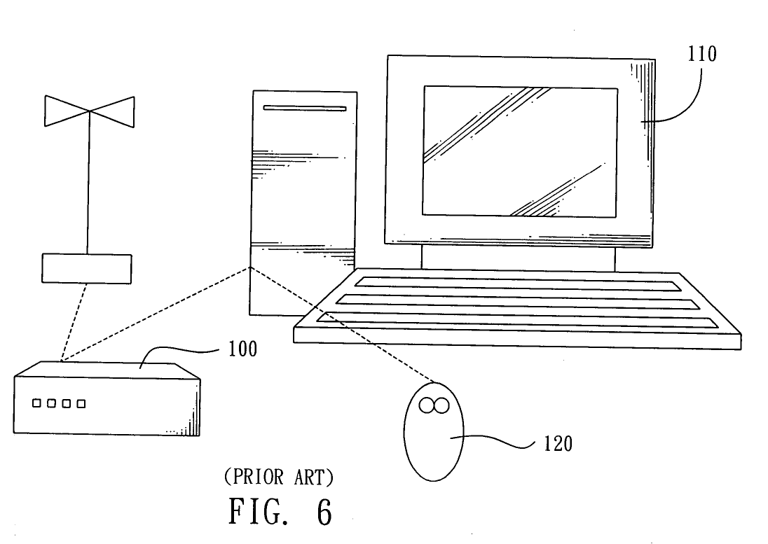

Refer to FIG. 5 for the schematic view of a mouse having a digital television receiving function and a computer 70 according to another preferred embodiment of the present invention. In the application, the wireless network unit 55 sends the coordinates of the mouse unit 20 and the digital television signal of the digital television receiver 30 to a wireless network receiving module (not shown in the figure) of the computer 70 via a wireless method, and users just need to use a software including but not limited to a Microsoft Media Player program on the computer device 70 to control and view the digital television program received by the digital television receiver 30, so as to further simplify the cable connection. Therefore, the present invention definitely can overcome the shortcomings of the prior art mouse and digital television receiver.

With the present invention, the casing of the mouse includes a built-in mouse unit and digital television receiver, so that the foregoing structure of the mouse can simplify the cable connection of the computer device, in addition to saving the purchasing cost for users. Therefore, the present invention definitely can overcome the shortcomings of the prior art mouse and digital television receiver.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A mouse having a digital television receiving function, comprising:
a casing, including an upper casing and a lower casing coupled with each other to define a containing space;
a mouse function unit, disposed in said containing space and having an interface for detecting mouse coordinates and sending out said mouse coordinates from said interface;
a digital television receiver, disposed in said containing space and further including an interface and a radio frequency interface;
an antenna, coupled to said radio frequency interface for receiving a radio digital television signal and sending said radio digital television signal to said digital television receiver for decoding said radio digital television signal into a digital television program signal; and
a hub, disposed in said containing space and separately coupled to said mouse function unit and said digital television receiver for coupling a computer device by a cable;
such that a user can use a software on said computer device to control and view a digital television program transmitted from said digital television receiver.

2. The mouse having a digital television receiving function of claim 1, wherein said containing space further comprises a printed circuit board for retaining said mouse function unit, said digital television receiver, said antenna, and said hub.

3. The mouse having a digital television receiving function of claim 1, wherein said interface is a USB interface and said hub is a USB hub.

4. The mouse having a digital television receiving function of claim 1, wherein said mouse function unit is an optical mouse or a trackball mouse.

5. The mouse having a digital television receiving function of claim 1, wherein said digital television receiver further comprises an infrared receiver exposed from said casing for receiving the control of a remote control.

6. The mouse having a digital television receiving function of claim 1, wherein said antenna is a built-in multi-frequency antenna.

7. The mouse having a digital television receiving function of claim 6, wherein said built-in multi-frequency antenna is a coil disposed in said containing space for receiving said radio digital television signal.

8. The mouse having a digital television receiving function of claim 6, wherein said built-in multi-frequency antenna is a ceramic antenna disposed in said containing space for receiving said radio digital television program.

9. The mouse having a digital television receiving function of claim 6, wherein said built-in multi-frequency antenna is a coil antenna disposed in said containing space by winding a coil for receiving said radio signal television signal.

10. The mouse having a digital television receiving function of claim 1, wherein said antenna is an external multi-frequency antenna.

11. The mouse having a digital television receiving function of claim 10, wherein said external multi-frequency antenna is an overflow antenna integrally coupled with said cable.

12. The mouse having a digital television receiving function of claim 1, wherein said software is a Microsoft Media Player program.

13. A mouse having a digital television receiving function, comprising:
a casing, including an upper casing and a lower casing coupled with each other to define a containing space;
a mouse function unit, disposed in said containing space and having an interface for detecting mouse coordinates and sending out said mouse coordinates from said interface;
a digital television receiver, disposed in said containing space and further including an interface and a radio frequency interface;
an antenna, coupled to said radio frequency interface for receiving a radio digital television signal and sending said radio digital television signal to said digital television receiver for decoding said radio digital television signal into a digital television program signal;
a hub, disposed in said containing space and coupled separately coupled to said mouse function unit and said digital television receiver; and
a wireless network unit, disposed in said containing space and coupled to said hub for connecting a computer device by a wireless method and sending said mouse coordinates and said digital television signal to said computer device;
such that a user can use a software on a computer device to control and view a digital television signal transmitted from said digital television receiver.

14. The mouse having a digital television receiving function of claim 13, wherein said containing space further comprises a printed circuit board for retaining said mouse function unit, said digital television receiver, said antenna, and said hub.

15. The mouse having a digital television receiving function of claim 13, wherein said interface is a USB interface and said hub is a USB hub.

16. The mouse having a digital television receiving function of claim 13, wherein said mouse function unit is an optical mouse or a trackball mouse.

17. The mouse having a digital television receiving function of claim 13, wherein said wireless network unit is an IEEE802.11a/b/c/d/g wireless network.

18. The mouse having a digital television receiving function of claim 13, wherein said antenna is a built-in multi-frequency antenna.

19. The mouse having a digital television receiving function of claim 18, wherein said built-in multi-frequency antenna is a coil disposed in said containing space for receiving said radio digital television signal.

20. The mouse having a digital television receiving function of claim 19, wherein said built-in multi-frequency antenna is a ceramic antenna disposed in said containing space for receiving said radio digital television signal.

21. The mouse having a digital television receiving function of claim 19, wherein said built-in multi-frequency antenna is a coil antenna disposed in said containing space by winding a coil for receiving said radio digital television signal.

22. The mouse having a digital television receiving function of claim 13, wherein said antenna is an external multi-frequency antenna.

23. The mouse having a digital television receiving function of claim 13, wherein said software is a Microsoft Media Player program.

24. The mouse having a digital television receiving function of claim 13, wherein said digital television receiver further comprises an infrared receiver exposed from said casing for receiving the control of a remote control.
